(19) United States
(12) Patent Application Publication
(10) Pub. No.: US 2006/0159938 A1
(43) Pub. Date: Jul. 20, 2006

(54) Composition for forming low dielectric thin film comprising polymer nanoparticles and method of preparing low dielectric thin film using the same

(75) Inventors: Jin Gyu Lee, Seoul (KR); Hyun Dam Jeong, Suwon-si (KR); Jong Baek Seon, Yeongin-si (KR); Hyeon Jin Shin, Suwon-si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG CORNING CO., LTD., Suwon-si (KR)

(21) Appl. No.: 11/335,689

(22) Filed: Jan. 20, 2006

(30) Foreign Application Priority Data
Jan. 20, 2005 (KR) 2005-5435

(51) Int. Cl. B32B 27/00; B05D 3/02; C08L 83/04; C08G 77/04

(52) U.S. Cl. 428/447; 428/327; 427/387; 524/588

(57) ABSTRACT

A composition for forming a low dielectric thin film, which includes a silane polymer, polymer nanoparticles, a porogen and an organic solvent, and a method of preparing a low dielectric thin film using the same. The low dielectric thin film prepared using the composition of this disclosure has a low dielectric constant and excellent mechanical strength. As well, the polymer nanoparticles in the low dielectric thin film have a uniform diameter and are soft, and thus are advantageously applied to a chemical-mechanical polishing process.

### CROSS-REFERENCE TO RELATED PATENT APPLICATION

Priority is claimed under 35 U.S.C. § 119(a) to Korean Patent Application No. 2005-5435 filed on Jan. 20, 2005, which is herein incorporated by reference.

### BACKGROUND OF THE DISCLOSURE

1. Field of the Disclosure

Embodiments of the present disclosure relate, generally, to a composition for forming a low dielectric thin film comprising polymer nanoparticles, and to a method of preparing a low dielectric thin film using the same. More specifically, embodiments of the present disclosure relate to a composition for forming a low dielectric thin film comprising polymer nanoparticles which is suitable for use in the formation of a thin film having excellent mechanical strength, and to a method of preparing a low dielectric thin film using the same.

2. Description of the Related Art

Along with the development of techniques for fabricating semiconductors, semiconductor devices have been manufactured to be miniaturized and more and more highly integrated. However, in the highly integrated semiconductor, signal transmission may be impeded due to interference between metal wires. Thus, the highly integrated semiconductor exhibits performance that depends on a signal transmission speed through the wiring. In order to lower resistance and capacitance of the metal wire, it is desired to reduce the capacitance of an interlayer dielectric film in the semiconductor.

Although a silicon oxidation film having a dielectric constant of about 4.0 has been typically used as the interlayer dielectric film of the semiconductor, it has reached its functional limits due to an increase of the integration of the semiconductor devices. Therefore, attempts have been made to decrease the dielectric constant of the dielectric film. In this regard, U.S. Pat. Nos. 3,615,272, 4,399,266, 4,756,977, and 4,999,397 disclose methods of manufacturing an interlayer dielectric film of a semiconductor using polysilsesquioxane having a dielectric constant of about 2.5 to 3.1.

Further, with the aim of reduction of the dielectric constant of the interlayer dielectric film of the semiconductor to 3.0 or less, a porogen-template method has been proposed, which includes mixing a siloxane-based resin with a porogen, and pyrolyzing the porogen at a temperature ranging from 250 to 350° C. to remove it.

U.S. Pat. No. 6,270,846 discloses a method of manufacturing a porous, surfactant-templated thin film, which includes mixing a precursor sol, a solvent, water, a surfactant and a hydrophobic polymer, applying the mixture on a substrate, and evaporating a portion of the solvent to form a thin film, which is then heated.

U.S. Pat. No. 6,329,017 discloses a method of manufacturing a low dielectric thin film, including mixing a silica precursor with an aqueous solvent, a catalyst and a surfactant, to prepare a precursor solution, spin coating a predetermined film with the precursor solution, and removing the aqueous solvent.

U.S. Pat. No. 6,387,453 discloses a method of manufacturing a mesoporous material, including mixing a precursor sol, a solvent, a surfactant and an interstitial compound to prepare a silica sol, and evaporating a portion of the solvent from the silica sol.

However, as shown in FIG. 1, such methods suffer because the pores may be connected to each other due to the breakage thereof upon the removal of the porogen or they may be irregularly dispersed, thus decreasing mechanical properties. Therefore, such a porous dielectric film is difficult to apply as an interlayer dielectric film of a semiconductor in terms of various chemical and mechanical processes.

### OBJECTS AND SUMMARY

Accordingly, embodiments of the present disclosure have been made keeping in mind the above problems occurring in the related art, and an object of embodiments of the present disclosure is to provide a composition for forming a low dielectric thin film comprising polymer nanoparticles, which can be used to prepare a low dielectric thin film having a low dielectric constant and excellent mechanical strength.

Another object of embodiments of the present disclosure is to provide a method of preparing a low dielectric thin film using polymer nanoparticles, which can be used to prepare a low dielectric thin film having a low dielectric constant and excellent mechanical strength, with low preparation cost by virtue of a simplified preparation process.

According to an aspect of embodiments of the present disclosure, in order to accomplish the above objects, a composition for forming a low dielectric thin film is provided, which comprises a silane polymer, polymer nanoparticles, a porogen and a solvent.

According to another aspect of embodiments of the present disclosure, a composition for forming a low dielectric thin film is provided, which comprises a silane monomer, polymer nanoparticles, a porogen, an acid (or a base) and water.

According to a further aspect of embodiments of the present disclosure, a method of preparing a low dielectric thin film using polymer nanoparticles is provided, the method comprising applying the composition comprising polymer nanoparticles of the present disclosure on a substrate and then curing the applied composition.

According to still a further aspect of the present disclosure, a method of preparing a low dielectric thin film using polymer nanoparticles is provided, the method comprising preparing a dispersion of the polymer nanoparticles; applying the dispersion obtained in a previous step on a substrate and then heat treating the applied dispersion; and applying a coating solution including a silane polymer or a silane monomer and a porogen on the heat treated dispersion and then curing the applied coating solution.

### BRIEF DESCRIPTION OF THE DRAWINGS

FIG. 1 is a view showing the problems caused upon forming a low dielectric thin film according to a conventional technique;

FIG. 2A is a view showing an FESEM (Field Emission Scanning Electron Microscope) image of the low dielectric thin film prepared without the use of polymer nanoparticles according to the conventional technique; and

FIG. 2B is a view showing an FESEM image of a low dielectric thin film, according to embodiments of the present disclosure.

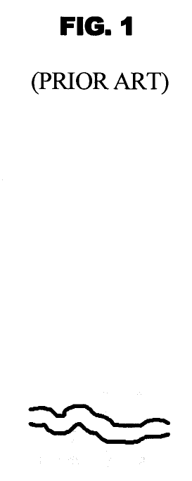

### DETAILED DESCRIPTION OF THE PREFERRED EMBODIMENTS

Hereinafter, a detailed description will be given of embodiments of the present invention, with reference to the appended drawings.

According to an aspect of embodiments of the present disclosure, a composition for the formation of a low dielectric thin film comprises a silane polymer, polymer nanoparticles, a porogen, and an organic solvent. Such a composition is applied on a substrate and then heat cured, thereby obtaining a low dielectric thin film having a very low dielectric constant and excellent mechanical strength. The low dielectric thin film thus obtained may be applied as an interlayer dielectric film of a semiconductor, having a low dielectric constant, and as well, may have various applications, including display materials, chemical sensors, biocatalysts, insulators, packaging materials, etc.

Although the silane polymer usable in embodiments of the present disclosure is not particularly limited, it may include, for example, a siloxane homopolymer prepared by hydrolyzing and polycondensing a monomer selected from the group consisting of a multi-reactive cyclic siloxane monomer represented by Formula 1 below, an Si monomer having an organic bridge represented by Formula 2 below, and a linear alkoxy silane monomer represented by Formula 3 below in an organic solvent in the presence of an acid catalyst or a base catalyst and water; or a siloxane copolymer prepared by hydrolyzing and polycondensing at least two monomers selected from the monomer group of Formulas 1, 2 and 3 in an organic solvent in the presence of an acid catalyst or a base catalyst and water:

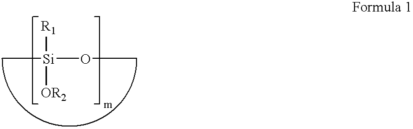

wherein R₁ is a hydrogen atom, a C₁˜C₃ alkyl group, or a C₆˜C₁₅ aryl group; R₂ is a hydrogen atom, a C₁˜C₁₀ alkyl group, or SiX₁X₂X₃ (in which X₁, X₂ and X₃ are independently each a hydrogen atom, a C₁˜C₃ alkyl group, a C₁˜C₁₀ alkoxy group, or a halogen atom); and m is an integer from 3 to 8;

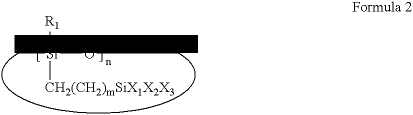

wherein R is a hydrogen atom, a C₁˜C₃ alkyl group, a C₃˜C₁₀ cycloalkyl group, or a C₆˜C₁₅ aryl group; X₁, X₂ and X₃ are independently each a C₁˜C₃ alkyl group, a C₁˜C₁₀ alkoxy group, or a halogen group; and n is an integer from 3 to 8, and m is an integer from 1 to 10; and
RSiX₁X₂X₃ Formula 3

wherein R is a hydrogen atom, a C₁˜C₃ alkyl group, an alkyl or aryl group containing fluorine, a C₃˜C₁₀ cycloalkyl group, or a C₆˜C₁₅ aryl group; X₁, X₂ and X₃ are independently each a C₁˜C₃ alkyl group, a C₁˜C₁₀ alkoxy group, or a halogen group.

Preferred examples of the cyclic siloxane monomer of Formula 1 of embodiments of the present disclosure include, but are not limited to, a compound (TS-T4Q4) represented by Formula 4 below obtained wherein R₁ is methyl, R₂ is Si(OCH₃)₃, and m is 4 in Formula 1:

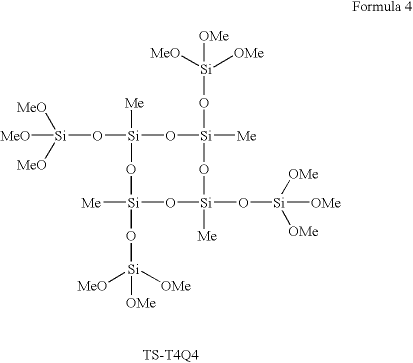

Preferred examples of the Si monomer having an organic bridge of Formula 2 include, but are not limited to, a compound (TCS-2) represented by Formula 5 below:

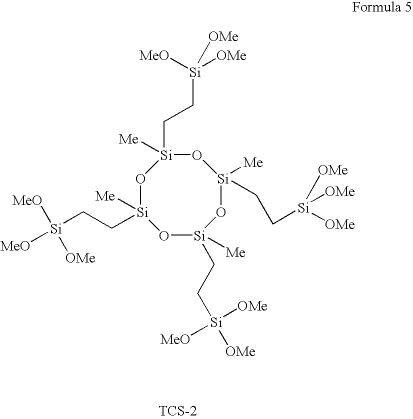

Specifically, examples of the linear alkoxy silane monomer of Formula 3 include, but are not limited to, methyltriethoxysilane, methyltrimethoxysilane, methyltri-n-propoxysilane, phenyltrimethoxysilane, phenyltriethoxysilane, phenyltrichlorosilane, phenyltrifluorosilane, phenethyltrimethoxysilane, methyltrichlorosilane, methyltribromosilane, methyltrifluorosilane, triethoxysilane, trimethoxysilane, trichlorosilane, trifluorosilane, 3,3,3-trifluoropropyl trimethoxysilane, cyanoethyltrimethoxysilane, etc.

The silane polymer usable in embodiments of the present disclosure may be prepared by homopolymerizing the cyclic siloxane monomer of Formula 2 or copolymerizing it with the linear alkoxy silane monomer of Formula 3.

In addition, the silane polymer usable in embodiments of the present disclosure may include a silsesquioxane polymer prepared by homopolymerizing the linear alkoxy silane monomer of Formula 3 or copolymerizing at least two alkoxy silane monomers selected from the alkoxy silane monomer group of Formula 3. The silsesquioxane polymer used in the present disclosure has a weight average molecular weight of between 1,000 and 100,000. Preferred examples of the silsesquioxane polymer include, but are not limited to, hydrogen silsesquioxane, alkyl silsesquioxane, aryl silsesquioxane, and copolymers thereof.

The polymer nanoparticles used in embodiments of the present disclosure are a polymer prepared through suspension polymerization, and are selected from the group consisting of polyvinylacetate, polystyrene, polymethylmethacrylate, polyvinylchloride, polyacrylamide, polytetrafluoroethylene, polyvinylidene fluoride, polyvinyl fluoride, polytrifluoroethylene, and polychlorotrifluoroethylene.

The polymer nanoparticles used in embodiments of the present disclosure may be provided in solution form obtained by dispersing polymer particles in a solid dispersant, a colloidal dispersant, or a solvent, or in solid form obtained as a precipitate by removing the solvent.

The polymer nanoparticles function to improve the mechanical strength of the low dielectric thin film prepared using the composition of the present disclosure, and have a uniform diameter and are soft, thus improving applicability to a chemical-mechanical polishing (CMP) process. In the present disclosure, the polymer nanoparticles preferably have a diameter of 1˜150 nm.

In the case where a dielectric film is prepared using the composition including the porogen as in the present disclosure, the thin film is heated to a temperature not lower than a decomposition temperature of the porogen, and thus the porogen should be decomposed. The porogen usable in embodiments of the present disclosure includes all of the porogens known for use in the formation of a porous dielectric film. Specifically, examples of the porogen include, but are not limited to, polycaprolactone, α-cyclodextrin, β-cyclodextrin, and γ-cyclodextrin.

In embodiments of the present disclosure, examples of a surfactant, which may be used as the porogen, include, but are not limited to, anionic surfactants, cationic surfactants, and nonionic surfactants or block copolymers. Examples of the anionic surfactant include, but are not limited to, sulfates, sulfonates, phosphates, and carboxylic acids. Examples of the cationic surfactant include, but are not limited to, alkylammonium salts, Gemini surfactants, cetylethylpiperidinium salts, and dialkyldimethylammonium. Examples of the nonionic surfactant include, but are not limited to, any one selected from the group consisting of Brij surfactants, primary amines, poly(oxyethylene)oxide, octaethylene glycol monodecyl ether, octaethylene glycol monohexadecyl ether, octylphenoxypolyethoxy(9-10)ethanol (Triton X-100), and block copolymers. The porogen is preferably used in an amount of 0.1 to 70 wt %, based on the total weight of the silane polymer and the porogen in the coating solution, but the amount thereof is not limited thereto. Examples of such a surfactant include, but are not limited to, polyethylene oxide-polypropylene oxide block copolymer of Formula 6, polyethyleneoxide-polypropyleneoxide-polyethyleneoxide triblock copolymer of Formula 7, a cyclodextrin derivative of Formula 8, cetyltrimethylammonium bromide (CTAB), octylphenoxypolyethoxy(9-10)ethanol (Triton X-100), and an ethylenediamine alkoxylate block copolymer:

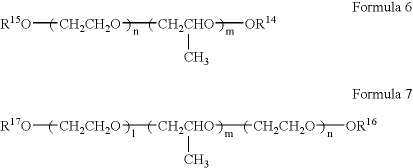

wherein R¹⁴, R¹⁵, R¹⁶ and R¹⁷ are independently each a hydrogen atom, a C₂˜C₃₀ acyl group, a C₁˜C₂₀ alkyl group, or a silicon (Si) compound represented by Sir₁r₂r₃, in which r₁, r₂ and r₃ are independently each a hydrogen atom, a C₁˜C₆ alkyl group, a C₁˜C₆ alkoxy group, or a C₆˜C₂₀ aryl group, and l is an integer from 2 to 200, m is an integer from 20 to 80, and n is an integer from 2 to 200; and

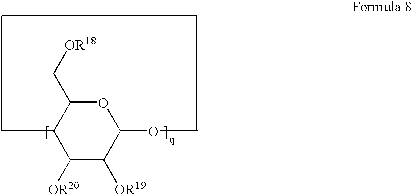

wherein R¹⁸, R¹⁹, and R²⁰ are independently each a hydrogen atom, a C₂˜C₃₀ acyl group, a C₁˜C₂₀ alkyl group, or a silicon (Si) compound represented by Sir₁r₂r₃, in which r₁, r₂ and r₃ are independently each a hydrogen atom, a C₁˜C₆ alkyl group, a C₁˜C₆ alkoxy group, or a C₆˜C₂₀ aryl group, and q is an integer from 5 to 8.

Polymer nanoparticles used in embodiments of the present disclosure are perfectly maintained without decomposition under curing conditions for formation of a dielectric film.

Examples of the organic solvent used in embodiments of the present disclosure include, but are not particularly limited to, aliphatic hydrocarbon solvents, such as hexane, heptane, etc.; aromatic hydrocarbon solvents, such as anisole, mesitylene, xylene, etc.; ketone-based solvents, such as methyl isobutyl ketone, 1-methyl-2-pyrrolidinone, cyclohexanone, acetone, etc.; ether-based solvents, such as tetrahydrofuran, isopropyl ether, etc.; acetate-based solvents, such as ethyl acetate, butyl acetate, propylene glycol methyl ether acetate, etc.; alcohol-based solvents, such as isopropyl alcohol, butyl alcohol, etc.; amide-based solvents, such as dimethylacetamide, dimethylformamide, etc.; silicon-based solvents; and combinations thereof.

The composition of embodiments of the present disclosure preferably includes 5˜70 wt % solid content based on the total weight thereof, but the solid content is not limited thereto. Particularly, it is preferred that the composition of embodiments of the present disclosure be composed of 1˜70 wt % of the silane polymer, 0.1˜70 wt % of the polymer nanoparticles, 0.1˜70 wt % of the porogen based on the total weight of the solid content of the composition, and 1˜90 wt % of the solvent.

According to another aspect of the present disclosure, a composition for forming a low dielectric thin film comprises a silane monomer, polymer nanoparticles, a porogen, an acid (or a base) catalyst, and water. The polymer nanoparticles and the porogen are as mentioned above.

Examples of the silane monomer usable in embodiments of the present disclosure include, but are not limited to, methyltriethoxysilane, methyltrimethoxysilane, methyltri-n-propoxysilane, phenyltrimethoxysilane, phenyltriethoxysilane, phenyltrichlorosilane, phenyltrifluorosilane, phenethyltrimethoxysilane, methyltrichlorosilane, methyltribromosilane, methyltrifluorosilane, triethoxysilane, trimethoxysilane, trichlorosilane, trifluorosilane, 3,3,3-trifluoropropyl trimethoxysilane, cyanoethyltrimethoxysilane, tetraethylorthosilicate, etc.

Examples of the acid catalyst usable in embodiments of the present disclosure include, but are not limited to, all of the acid catalysts known for preparation of polysilsesquioxane, and preferably hydrochloric acid, nitric acid, benzene sulfonic acid, oxalic acid, and formic acid. Examples of the base catalyst include, but are not limited to, potassium hydroxide, sodium hydroxide, triethylamine, sodium bicarbonate, and pyridine.

According to a further aspect of embodiments of the present disclosure, a method of preparing a low dielectric thin film using the above-mentioned composition is provided. The low dielectric thin film of the present disclosure may be prepared by mixing a silane polymer, polymer nanoparticles, a porogen and an organic solvent together to prepare a coating solution, applying the coating solution on a substrate, and then curing the applied coating solution.

Alternatively, a silane monomer, polymer nanoparticles, a progen, an acid or a base catalyst, and water may be mixed together to prepare a coating solution, which is then applied on a substrate and subsequently cured, thus obtaining a desired thin film.

According to still a further aspect of embodiments of the present disclosure, a method of preparing a low dielectric thin film is provided, the method comprising preparing a dispersion of polymer nanoparticles, applying the dispersion on a substrate using spin coating, heat treating the applied dispersion, applying a solution of a silane monomer or a silane polymer including a porogen on the heat treated dispersion, and curing the applied solution.

The substrate is not particularly limited so long as it does not hinder the purposes of embodiments of the present disclosure. Any substrate that is able to endure heat curing conditions may be used, and examples thereof include, but are not limited to, a glass substrate, a silicon wafer, a plastic substrate, etc., depending on end uses.

Moreover, examples of a process of coating the substrate with the composition include, but are not limited to, spin coating, dip coating, spray coating, flow coating, and screen printing. Of these coating processes, a spin coating process is preferable in terms of convenience and uniformity. In the case of conducting the spin coating process, the spin rate may be preferably controlled in the range of from 800 to 5,000 rpm. After the completion of the coating process, a process of evaporating the solvent to dry the film may be further included, if required. As such, the film may be dried by simply exposing it to external environments, applying a vacuum upon initial curing, or heating it to a relatively low temperature of 200° C. or less.

Subsequently, the film is heat cured, thus forming an insoluble film having no cracks. The heating conditions may be controlled depending on the composition of the coating solution. That is, in the case where an ordered structure is formed using the surfactant as the porogen, an ordering effect is further enhanced as a heat curing time is prolonged at a low heat curing temperature. Generally, a pre-heating process is conducted at 60˜170° C. for a time period from 1 min to 24 hours and then a second-heating process is conducted at 300˜400° C. for a time period from 10 min to 48 hours. In addition, in the case where cyclodextrin or polycaprolactone is used as the porogen, it is preferred that a pre-heating process at 60˜170° C. for a time period from 1 min to 24 hours, a second-heating process at 200˜300° C. for a time period from 1 min to 24 hours, and a third-heating process at 300˜400° C. for a time period from 10 min to 48 hours be continuously conducted.

A better understanding of embodiments of the present invention may be obtained in light of the following examples which are set forth to illustrate, but are not to be construed to limit the present invention.

### EXAMPLE 1

Preparation of Silane Polymer A

8.24 mmol of a monomer of Formula 4 (TS-T4Q4) and 3.53 mmol of methyltrimethoxysilane (MTMS, Aldrich) as an alkoxy silane monomer were charged into a flask, and then diluted with tetrahydrofuran (THF) such that the total concentration of a solution was 0.05˜0.07 M. The temperature of the reaction solution was decreased to −78° C. The reaction solution was added with 0.424 mmol of hydrochloric acid and 141.2 mmol of water, the temperature of which was gradually increased from −78° C. to 70° C. At this temperature, the reaction solution was allowed to react for 16 hours. The resultant solution was transferred into a separate funnel, into which diethylether and THF were added in amounts equal to the initially added THF. The reaction solution was washed three times with water corresponding to about 1/10 of the total amount of the solvent, and volatile material was removed under reduced pressure to obtain a white powdery polymer. The polymer thus obtained was dissolved in THF to make a transparent solution, which was then filtered through a filter having 0.2 μm-sized pores. Water was slowly added to the filtrate to precipitate white powder. The white powder was dried at 0˜20° C. under 0.1 torr for 10 hours, thus yielding a siloxane polymer A. The amounts of monomers used in preparation the polymer and the amounts of HCl and water used are given in Table 1 below. In addition, the amounts of the resultant polymer, Si—OH, Si—OCH₃, and Si—CH₃ are shown in Table 1 below. The amounts of Si—OH, Si—OCH₃ and Si—CH₃ were analyzed using a nuclear magnetic resonator (NMR, Bruker).

TABLE 1

| | | | | | Amount of | | | |
|---|---|---|---|---|---|---|---|---|
| | TS-T4Q4 | MTMS | HCl | H₂O | Resulting | Si—OH | Si—OCH₃ | Si—CH₃ |
| Polymer | (mmol) | (mmol) | (mmol) | (mmol) | Polymer (g) | (%) | (%) | (%) |
| A | 5.09 | 20.36 | 1.222 | 407.2 | 3.70 | 33.60 | 1.30 | 65.10 |

### EXAMPLE 2

Preparation of Silane Polymer B

A siloxane monomer of Formula 5 (TCS-2), having a cyclic structure, and MTMS diluted with 100 ml of THF were charged into a flask, and the internal temperature of the flask was decreased to −78° C. At −78° C., a predetermined amount of hydrochloric acid (HCl) was diluted with a predetermined amount of deionized water, to which water was slowly added. The temperature of the reaction solution was gradually increased to 70° C., and the solution was allowed to react at 60° C. for 16 hours. Subsequently, the resultant reaction solution was transferred into a separate funnel, added with 150 ml of diethylether, and washed three times with 30 ml of water. The volatile material was removed under reduced pressure from the reaction solution, thus obtaining a white powdery polymer. The polymer thus obtained was dissolved in a small amount of acetone, after which the polymer solution was filtered using a filter having 0.2 μm-sized pores to remove fine powder and impurities. To only the clear solution was slowly added water. The produced white powder was separated from the solution (mixture solution of acetone and water), and then dried at 0˜5° C. under reduced pressure of 0.1 torr, thus yielding a siloxane composition. The amounts of monomers, acid catalyst and water used for synthesis of the precursor and the amount of the resultant siloxane polymer are given in Table 2 below.

TABLE 2

| | TCS-2 | MTMS | | H₂O | Amount of |
|---|---|---|---|---|---|
| Polymer | (mmol) | (mmol) | HCl (mmol) | (mmol) | Result. Polymer (g) |
| B | 3.895 | 35.045 | 0.015 | 506.289 | 4.21 |

### EXAMPLES 3˜5

0.02 g/ml of polystyrene nanoparticles were uniformly dispersed in deionized water to prepare a coating solution I, which was then applied on a silicon wafer at 500 rpm for 30 sec using spin coating, pre-heated at 150° C. for 1 min on a hot plate in a nitrogen atmosphere and then dried to prepare a film. Separately, 0.75 g of the silane polymer B and cetyltrimethylammonium bromide, serving as the porogen, was completely dissolved in 4 g of anhydrous ethanol to prepare a coating solution II. As such, the weight ratio of silane polymer and porogen varied as shown in Table 3 below. The coating solution II thus obtained was applied on a substrate coated with the polystyrene nanoparticles, pre-heated at 150° C. for 1 min, heat treated at 400° C. (temperature increase rate: 3° C./min) for 1 hour in a vacuum atmosphere, to manufacture a dielectric film. Thereafter, thickness, refractive index, dielectric constant, hardness and elastic modulus of the dielectric film thus manufactured were measured. The results are given in Table 3 below.

[Measurement of Physical Properties]

The physical properties of the dielectric film were assayed according to the following procedures.

1) Measurement of Dielectric Constant

A silicon heat oxidation film was applied to a thickness of 3000 Å on a boron-doped p-type silicon wafer, and a 100 Å thick titanium layer, a 2000 Å thick aluminum layer, and a 100 Å thick titanium layer were sequentially deposited on the silicon film using a metal evaporator. Subsequently, a dielectric film was formed on the outermost metal layer. On the dielectric film, a 100 Å thick circular titanium film and a 5000 Å thick circular aluminum film, each having a diameter of 1 mm, were deposited, using a hard mask designed to have an electrode diameter of 1 mm, to obtain an MIM (metal-insulator-metal) structural thin film having a low dielectric constant for use in the measurement of dielectric constants. The capacitance of the thin film thus obtained was measured at frequencies of about 10 kHz, 100 kHz and 1 MHz using a Precision LCR meter (HP4284A) equipped with a micromanipulator 6200 probe station. In addition, the thickness of the thin film was measured using a prism coupler. The dielectric constant was calculated from the following equation:

$$k = \frac{C \times d}{{ɛ}_{0} \times A}$$

wherein k is a dielectric constant, C is a capacitance, ε₀ is a dielectric constant in a vacuum (ε₀=8.8542×10⁻¹² Fm⁻¹), d is a thickness of a dielectric film, and A is a cross-sectional area in contact with an electrode.

2) Thickness and Refractive Index

The thickness and refractive index of the thin film were measured using a prism coupler and an ellipsometer.

3) Hardness and Elastic Modulus

The hardness and elastic modulus of the thin film were quantitatively analyzed using a nanoindenter II available from MTS. The thin film was indented with the nanoindenter, and the hardness and elastic modulus of the thin film were measured when the indented depth was 10% of the film thickness. The thickness of the thin film was measured using a prism coupler. In the Examples and Comparative Example, in order to assure the reliability of the thin film, six spots on the dielectric film were indented, from which the average value was determined to measure the hardness and elastic modulus of each film.

### COMPARATIVE EXAMPLES 1˜3

Each dielectric film was prepared in the same manner as in Examples 3˜5, with the exception that the polystyrene nanoparticles were not used upon preparation of the coating solution. The properties of the film were measured. The results are given in Table 3 below.

TABLE 3

| | Weight | | | | | |
|---|---|---|---|---|---|---|
| | Ratio of | | | Dielect. | | |
| | Silane | | | Constant | Elastic | Hard- |
| | Polymer: | Thick. | Refract. | (k) | Modulus | ness |
| No. | Porogen | (nm) | Index | 1 MHz | (GPa) | (GPa) |
| Ex. 3 | 9:1 | 950 | 1.378 | 3.28 | 5.63 | 0.97 |
| Ex. 4 | 8:2 | 911 | 1.346 | 2.98 | 4.69 | 0.86 |
| Ex. 5 | 7:3 | 879 | 1.309 | 2.43 | 3.76 | 0.67 |
| C. Ex. 1 | 9:1 | 890 | 1.371 | 3.48 | 4.02 | 0.76 |
| C. Ex. 2 | 8:2 | 905 | 1.350 | 2.90 | 4.57 | 0.81 |
| C. Ex. 3 | 7:3 | 864 | 1.310 | 2.49 | 3.57 | 0.59 |

### EXAMPLES 6˜8

Each dielectric film was prepared in the same manner as in Examples 3˜5, with the exception that the polymer A was used as the silane polymer. The properties of the film were measured. The results are given in Table 4 below.

### COMPARATIVE EXAMPLES 4˜7

Each dielectric film was prepared in the same manner as in Example 6, with the exception that the polystyrene nanoparticles were not used upon preparation of the coating solution, and the weight ratio of silane polymer and porogen varied as shown in Table 4 below. The properties of the film were measured. The results are given in Table 4 below.

TABLE 4

| | Weight | | | | | |
|---|---|---|---|---|---|---|
| | Ratio of | | | | | |
| | Silane | | | Dielect. | Elastic | Hard- |
| | Polymer: | Thick. | Refract. | Constant (k) | Modulus | ness |
| No. | Porogen | (nm) | Index | 1 MHz | (GPa) | (GPa) |
| Ex. 6 | 9:1 | 841 | 1.355 | 2.71 | 8.41 | 1.49 |
| Ex. 7 | 8:2 | 897 | 1.278 | 2.36 | 4.78 | 0.79 |
| Ex. 8 | 7:3 | 725 | 1.233 | 1.62 | 2.66 | 2.44 |
| C. Ex. 4 | 9:1 | 535 | 1.351 | 2.72 | 8.63 | 1.47 |
| C. Ex. 5 | 8:2 | 539 | 1.265 | 2.40 | 4.36 | 0.72 |
| C. Ex. 6 | 7:3 | 527 | 1.240 | 2.08 | 2.44 | 0.40 |
| C. Ex. 7 | 6:4 | 461 | 1.236 | 1.70 | 1.91 | 0.30 |

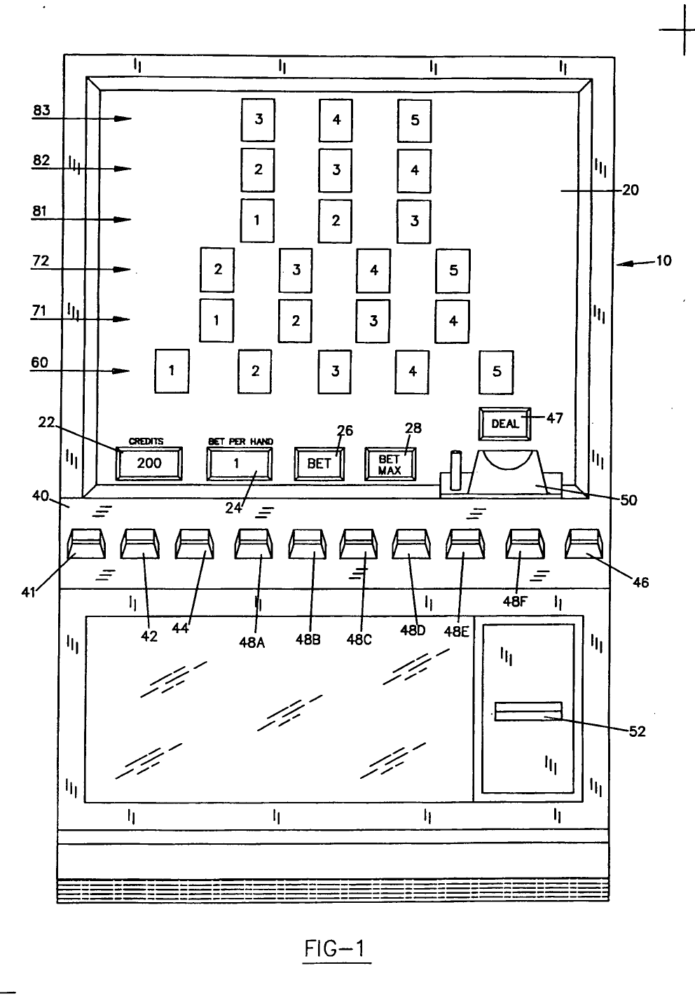

The FESEM image of the low dielectric thin film prepared in Example 8 is shown in FIG. 2B. For comparison, the FESEM image of the low dielectric thin film prepared without the use of the polymer nanoparticles in Comparative Example 4 is shown in FIG. 2A. As shown in FIG. 2B, the resultant low dielectric thin film is confirmed to be very uniform, without cracks, and to include polymer nanoparticles therein, in which the polymer nanoparticles function to enhance the mechanical strength of the thin film.

### EXAMPLES 9˜10

Each dielectric film was prepared in the same manner as in Examples 6˜7, with the exception that cyclodextrin was used as the porogen. The dielectric film was soft baked at 150° C. for 1 min in a nitrogen atmosphere and then cured at 250° C. for 1 min and then at 400° C. for 1 hour. The properties of the film were measured. The results are given in Table 5 below.

### COMPARATIVE EXAMPLES 8˜9

Each dielectric film was prepared in the same manner as in Example 9, with the exception that the polystyrene nanoparticles were not used upon preparation of the coating solution, and the weight ratio of silane polymer and porogen varied as shown in Table 5 below. The properties of the film were measured. The results are given in Table 5 below.

TABLE 5

| | Weight Ratio | | | | |
|---|---|---|---|---|---|
| | of Silane | | Dielect. | Elastic | |
| | Polymer: | Thick. | Constant (k) | Modulus | Hardness |
| No. | Porogen | (nm) | 1 MHz | (GPa) | (GPa) |
| Ex. 9 | 9:1 | 370 | 3.04 | 10.50 | 1.57 |
| Ex. 10 | 8:2 | 326 | 2.79 | 8.16 | 1.17 |
| C. Ex. 8 | 9:1 | 300 | 3.2 | 10.41 | 1.31 |
| C. Ex. 9 | 8:2 | 275 | 2.86 | 8.31 | 1.02 |

### EXAMPLES 11˜12

Each dielectric film was prepared in the same manner as in Examples 9˜10, with the exception that the polymer B was used as the silane polymer. The properties of the film were measured. The results are given in Table 6 below.

### COMPARATIVE EXAMPLES 10˜11

Each dielectric film was prepared in the same manner as in Examples 11˜12, with the exception that the polystyrene nanoparticles were not used upon preparation of the coating solution. The properties of the film were measured. The results are given in Table 6 below.

TABLE 6

| | Weight Ratio | | | | |
|---|---|---|---|---|---|
| | of Silane | | Dielect. | Elastic | |
| | Polymer: | Thick. | Constant (k) | Modulus | Hardness |
| No. | Porogen | (nm) | 1 MHz | (GPa) | (GPa) |
| Ex. 11 | 9:1 | 415 | 2.79 | 5.43 | 0.91 |
| Ex. 12 | 8:2 | 404 | 2.49 | 4.52 | 0.75 |
| C. Ex. 10 | 9:1 | 371 | 2.8 | 5.41 | 0.75 |
| C. Ex. 11 | 8:2 | 338 | 2.51 | 5.21 | 0.73 |

### EXAMPLES 13˜16

0.02 g/ml of polystyrene nanoparticles, 0.45 g of the silane polymer A and 0.05 g (Ex. 13), 0.1 g (Ex. 14), 0.15 g (Ex. 15) and 0.2 g (Ex. 16) of cetyltrimethylammonium bromide were completely dissolved in 4 g of anhydrous ethanol, to prepare each coating solution. Subsequently, the coating solution was applied onto a silicon wafer using spin coating, pre-heated at 150° C. for 30 min, and heat treated at 400° C. (temperature increase rate: 3° C./min) for 1 hour in a nitrogen atmosphere, to prepare a dielectric film. The thickness, dielectric constant, hardness and elastic modulus of the dielectric film thus prepared were measured. The results are given in Table 7 below.

### COMPARATIVE EXAMPLES 12˜15

Each dielectric film was prepared in the same manner as in Example 13, with the exception that the polystyrene nanoparticles were not used upon preparation of the coating solution. The properties of the film were measured. The results are given in Table 7 below.

TABLE 7

| | Weight Ratio | | | | |
|---|---|---|---|---|---|
| | of Silane | | Dielect. | Elastic | |
| | Polymer: | Thick. | Constant (k) | Modulus | Hardness |
| No. | Porogen | (nm) | 1 MHz | (GPa) | (GPa) |
| Ex. 13 | 9:1 | 654 | 2.81 | 7.58 | 1.14 |
| Ex. 14 | 8:2 | 528 | 2.74 | 4.48 | 0.67 |
| Ex. 15 | 7:3 | 557 | 2.44 | 2.85 | 0.44 |
| Ex. 16 | 6:4 | 426 | 1.96 | 2.08 | 0.31 |
| C. Ex. 12 | 9:1 | 535 | 2.7 | 8.02 | 1.29 |
| C. Ex. 13 | 8:2 | 539 | 2.33 | 5.05 | 0.89 |
| C. Ex. 14 | 7:3 | 527 | 2.04 | 4.01 | 0.65 |
| C. Ex. 15 | 6:4 | 461 | 1.64 | 1.99 | 0.32 |

### EXAMPLES 17˜18

Each dielectric film was prepared in the same manner as in Example 13, with the exception that the polymer B was used as the silane polymer. The properties of the film were measured. The results are given in Table 8 below.

### COMPARATIVE EXAMPLES 16˜17

Each dielectric film was prepared in the same manner as in Example 17, with the exception that the polystyrene nanoparticles were not used upon preparation of the coating solution, and the weight ratio of silane polymer and porogen varied as shown in Table 8 below. The properties of the film were measured. The results are given in Table 8 below.

TABLE 8

| | Weight Ratio | | | | |
|---|---|---|---|---|---|
| | of Silane | | Dielect. | Elastic | |
| | Polymer: | Thick. | Constant (k) | Modulus | Hardness |
| No. | Porogen | (nm) | 1 MHz | (GPa) | (GPa) |
| Ex. 17 | 8:2 | 484 | 2.11 | 3.71 | 0.60 |
| Ex. 18 | 7:3 | 522 | 2.16 | 2.67 | 0.43 |
| C. Ex. 16 | 9:1 | 1498 | 2.43 | 4.79 | 0.88 |
| C. Ex. 17 | 7:3 | 1202 | 2.18 | 2.93 | 0.52 |

### EXAMPLE 19

0.5 g of cetyltrimethylammonium bromide was dissolved in 10 g of ethanol, into which methyltriethoxysilane was then dissolved. Subsequently, the resultant solution was added with 0.02 g of polystyrene latex nanoparticles and stirred. Finally, to the stirred solution was added 0.7 g of 0.1 M dil. HCl aqueous solution, followed by stirring the reaction solution for complete mixing to prepare a coating solution for preparation of a thin film. The coating solution was applied on a silicon wafer at 3000 rpm for 30 sec using spin coating, pre-heated at 150° C. for 1.5 hours on a hot plate in a nitrogen atmosphere and dried to prepare a film. The film was heat treated at 400° C. (temperature increase rate: 3° C./min) for 1 hour in a nitrogen atmosphere to prepare a dielectric film. The properties of the dielectric film thus prepared were measured. The results are given in Table 9 below.

### COMPARATIVE EXAMPLE 18

A dielectric film was prepared in the same manner as in Example 19, with the exception that the polystyrene nanoparticles were not used upon preparation of the coating solution. The properties of the film were measured. The results are given in Table 9 below.

TABLE 9

| | Weight Ratio | | | | |
|---|---|---|---|---|---|
| | of Silane | | Dielect. | Elastic | |
| | Monomer: | Thick. | Constant (k) | Modulus | Hardness |
| No. | Porogen | (nm) | 1 MHz | (GPa) | (GPa) |
| Ex. 19 | 7:3 | 765 | 2.15 | 7.8 | 1.20 |
| C. Ex. 18 | 7:3 | 700 | 2.20 | 7.2 | 1.14 |

As previously described herein, the present disclosure provides a composition for forming a low dielectric thin film comprising polymer nanoparticles and a method of preparing a low dielectric thin film using the same. According to the method of the present disclosure, the polymer nanoparticles included in the thin film function to enhance mechanical strength. Further, the polymer nanoparticles used in the present disclosure have a uniform diameter and are soft and thus advantageously applied to a chemical-mechanical polishing process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition for forming a low dielectric thin film, comprising a silane polymer, polymer nanoparticles, a porogen, and a solvent.

2. The composition as set forth in claim 1, wherein the polymer nanoparticles comprise at least one selected from the group consisting of polyvinylacetate, polystyrene, polymethylmethacrylate, polyvinylchloride, polyacrylamide, polytetrafluoroethylene, polyvinylidene fluoride, polyvinyl fluoride, polytrifluoroethylene, and polychlorotrifluoroethylene.

3. The composition as set forth in claim 2, wherein the polymer nanoparticles have a diameter of 1˜150 nm.

4. The composition as set forth in claim 1, wherein the silane polymer is a siloxane homopolymer prepared by hydrolyzing and polycondensing a monomer selected from the group consisting of a multi-reactive cyclic siloxane monomer of Formula 1 below, an Si monomer having an organic bridge of Formula 2 below, and a linear alkoxy silane monomer of Formula 3 below in an organic solvent in the presence of an acid catalyst (or a base catalyst) and water; or a siloxane copolymer prepared by hydrolyzing and polycondensing at least two monomers selected from the monomer group of Formulas 1, 2 and 3 in an organic solvent in the presence of an acid catalyst (or a base catalyst) and water: 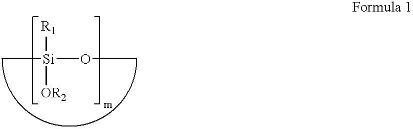
wherein R₁ is a hydrogen atom, a C₁˜C₃ alkyl group, or a C₆˜C₁₅ aryl group; R₂ is a hydrogen atom, a C₁˜C₁₀ alkyl group, or SiX₁X₂X₃ (in which X₁, X₂ and X₃ are independently each a hydrogen atom, a C₁˜C₃ alkyl group, a C₁˜C₁₀ alkoxy group, or a halogen atom); and m is an integer from 3 to 8; 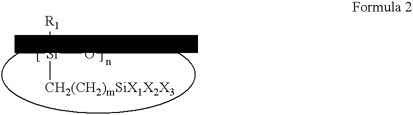
wherein R is a hydrogen atom, a C₁˜C₃ alkyl group, a C₃˜C₁₀ cycloalkyl group, or a C₆˜C₁₅ aryl group; X₁, X₂ and X₃ are independently each a C₁˜C₃ alkyl group, a C₁˜C₁₀ alkoxy group, or a halogen group; and n is an integer from 3 to 8, and m is an integer from 1 to 10; and
RSiX₁X₂X₃ Formula 3
wherein R is a hydrogen atom, a C₁˜C₃ alkyl group, an alkyl or aryl group containing fluorine, a C₃˜C₁₀ cycloalkyl group, or a C₆˜C₁₅ aryl group; X₁, X₂ and X₃ are independently each a C₁˜C₃ alkyl group, a C₁˜C₁₀ alkoxy group, or a halogen group.

5. The composition as set forth in claim 1, wherein the silane polymer is a silsesquioxane polymer selected from the group consisting of hydrogen silsesquioxane, alkyl silsesquioxane, aryl silsesquioxane, and copolymers thereof.

6. The composition as set forth in claim 1, wherein the porogen is selected from the group consisting of polycaprolactone, α-cyclodextrin, β-cyclodextrin, and γ-cyclodextrin, or is a surfactant selected from the group consisting of sulfates, sulfonates, phosphates, carboxylic acids, alkylammonium salts, Gemini surfactants, cetylethylpiperidinium salts, dialkyldimethylammonium, Brij surfactants, primary amines, poly(oxyethylene)oxide, octaethylene glycol monodecyl ether, octaethylene glycol monohexadecyl ether, octylphenoxypolyethoxy(9-10)ethanol (Triton X-100), and polyethyleneoxide-polypropyleneoxide-polyethyleneoxide triblock copolymers.

7. The composition as set forth in claim 1, which comprises 1˜70 wt % of the silane polymer, 0.1˜70 wt % of the polymer nanoparticles, 0.1˜70 wt % of the porogen based on a total weight of a solid content of the composition, and 1˜90 wt % of the solvent.

8. The composition as set forth in claim 1, wherein the solvent is selected from the group consisting of aliphatic hydrocarbon solvents, aromatic hydrocarbon solvents, ketone-based solvents, ether-based solvents, acetate-based solvents, alcohol-based solvents, amide-based solvents, silicon-based solvents, and mixtures thereof.

9. A composition for forming a low dielectric thin film, comprising a silane monomer, polymer nanoparticles, a porogen, an acid catalyst or a base catalyst, and water.

10. The composition as set forth in claim 9, wherein the polymer nanoparticles comprise at least one selected from the group consisting of poly(vinyl)acetate, polystyrene, poly(methylmethacrylate), poly(vinylchloride), poly(acrylamide), poly(tetrafluoroethylene), poly(vinylidene fluoride), poly(vinyl fluoride), poly(trifluoroethylene), and poly(chlorotrifluoroethylene).

11. The composition as set forth in claim 10, wherein the polymer nanoparticles have a diameter of 1˜150 nm.

12. The composition as set forth in claim 9, wherein the silane monomer is selected from the group consisting of methyltriethoxysilane, methyltrimethoxysilane, methyltri-n-propoxysilane, phenyltrimethoxysilane, phenyltriethoxysilane, phenyltrichlorosilane, phenyltrifluorosilane, phenethyltrimethoxysilane, methyltrichlorosilane, methyltribromosilane, methyltrifluorosilane, triethoxysilane, trimethoxysilane, trichlorosilane, trifluorosilane, 3,3,3-trifluoropropyl trimethoxysilane, cyanoethyltrimethoxysilane, and tetraethylorthosilicate.

13. The composition as set forth in claim 9, wherein the acid catalyst is selected from the group consisting of hydrochloric acid, nitric acid, benzene sulfonic acid, oxalic acid, formic acid, and mixtures thereof, and the base catalyst is selected from the group consisting of sodium hydroxide, tetramethylammonium hydroxide (TPAOH), potassium hydroxide, and mixtures thereof.

14. The composition as set forth in claim 9, wherein the porogen is selected from the group consisting of polycaprolactone, α-cyclodextrin, β-cyclodextrin, and γ-cyclodextrin, or is a surfactant selected from the group consisting of sulfates, sulfonates, phosphates, carboxylic acids, alkylammonium salts, Gemini surfactants, cetylethylpiperidinium salts, dialkyldimethylammonium, BRij surfactants, primary amines, poly(oxyethylene)oxide, octaethylene glycol monodecyl ether, octaethylene glycol monohexadecyl ether, octylphenoxypolyethoxy(9-10)ethanol (Triton X-100), and polyethyleneoxide-polypropyleneoxide-polyethyleneoxide triblock copolymers.

15. A method of preparing a low dielectric thin film using polymer nanoparticles, comprising applying the composition of claim 1 on a substrate and then curing the composition.

16. The method as set forth in claim 15, wherein the applying of the composition is conducted through spin coating, dip coating, spray coating, flow coating, or screen printing.

17. The method as set forth in claim 15, wherein the curing of the composition is conducted by subjecting the composition to pre-heating at 60˜170° C. for a time period from 1 min to 24 hours, second-heating at 200˜300° C. for a time period from 1 min to 24 hours, and then third-heating at 300˜400° C. for a time period from 10 min to 48 hours.

18. The method as set forth in claim 15, wherein the curing of the composition is conducted by subjecting the composition to pre-heating at 60˜170° C. for a time period from 1 min to 24 hours and then second-heating at 300˜400° C. for a time period from 10 min to 48 hours in a case where a surfactant is used as a porogen.

19. A method of preparing a low dielectric thin film using polymer nanoparticles, comprising applying the composition of claim 9 on a substrate and then curing the composition.

20. The method as set forth in claim 19, wherein the applying of the composition is conducted through spin coating, dip coating, spray coating, flow coating, or screen printing.

21. The method as set forth in claim 19, wherein the curing of the composition is conducted by subjecting the composition to pre-heating at 60˜170° C. for a time period from 1 min to 24 hours, second-heating at 200˜300° C. for a time period from 1 min to 24 hours, and then third-heating at 300˜400° C. for a time period from 10 min to 48 hours.

22. The method as set forth in claim 19, wherein the curing of the composition is conducted by subjecting the composition to pre-heating at 60˜170° C. for a time period from 1 min to 24 hours and then second-heating at 300˜400° C. for a time period from 10 min to 48 hours in a case where a surfactant is used as a porogen.

23. A method of preparing a low dielectric thin film using polymer nanoparticles, comprising:
preparing a dispersion of the polymer nanoparticles;
applying the dispersion obtained in a previous step on a substrate and then heat treating the applied dispersion; and
applying a-coating solution including a silane polymer or a silane monomer and a porogen on the heat treated dispersion and curing the coating solution.

24. The method as set forth in claim 23, wherein the applying of the dispersion or applying of the coating solution is conducted through spin coating, dip coating, spray coating, flow coating, or screen printing.

25. The method as set forth in claim 23, wherein the curing of the coating solution is conducted by subjecting the coating solution to pre-heating at 60˜170° C. for a time period from 1 min to 24 hours, second-heating at 200˜300° C. for a time period from 1 min to 24 hours, and then third-heating at 300˜400° C. for a time period from 10 min to 48 hours.

26. The method as set forth in claim 23, wherein the curing of the coating solution is conducted by subjecting the coating solution to pre-heating at 60˜170° C. for a time period from 1 min to 24 hours and then second-heating at 300˜400° C. for a time period from 10 min to 48 hours in a case where a surfactant is used as the porogen.

27. A dielectric film provided between layers of a semiconductor, prepared using the composition of claim 1.

28. A dielectric film provided between layers of a semiconductor, prepared using the composition of claim 9.
